(19) United States
(12) Patent Application Publication
(10) Pub. No.: US 2026/0104307 A1
(43) Pub. Date: Apr. 16, 2026

(54) PIPELINE IN-LINE INSPECTION TOOL BASED ON DISTRIBUTED MAGNETIC UNIFORMITY SENSING

(71) Applicant: Deyuan Technology Co., Ltd., Chengdu (CN)

(72) Inventors: Fei LUO, Chengdu (CN); Bin GAO, Chengdu (CN); Shiqiang JIANG, Chengdu (CN); Gaige RU, Chengdu (CN); Yong ZHANG, Chengdu (CN); Songwen XUE, Chengdu (CN); Qiuping MA, Chengdu (CN); Peng LU, Chengdu (CN); Honghai LU, Chengdu (CN); Shuai CHEN, Chengdu (CN); Donghai TANG, Chengdu (CN)

(73) Assignee: Deyuan Technology Co., Ltd., Chengdu (CN)

(21) Appl. No.: 19/303,394

(22) Filed: Aug. 19, 2025

(30) Foreign Application Priority Data
Oct. 15, 2024 (CN) 202411435909.X

(51) Int. Cl. G01M 3/00; G01N 27/82

(52) U.S. Cl. CPC G01M 3/005; G01N 27/82

(57) ABSTRACT

A pipeline in-line inspection tool based on distributed magnetic uniformity sensing includes a mobile carrier and a probe inspection assembly. The mobile carrier moves in a pipeline, a plurality of probe inspection assemblies are arranged on an outer side of the mobile carrier, and the plurality of probe inspection assemblies are distributed in sequence along an axis of the mobile carrier. The probe inspection assembly includes a plurality of elastic inspection ends, and the plurality of elastic inspection ends are distributed and arranged around the axis of the mobile carrier. The elastic inspection end is provided with an excitation structure, an inspection component and a wear-resistant structure. During inspection, the elastic inspection end is in abutment with an inner wall of the pipeline, the pipeline is magnetized through the excitation structure, and pipeline defects in magnetized areas are detected through the inspection component.

### CROSS REFERENCE TO THE RELATED APPLICATIONS

This application is based upon and claims priority to Chinese Patent Application No. 202411435909.X, filed on Oct. 15, 2024, the entire contents of which are incorporated herein by reference.

### TECHNICAL FIELD

The invention belongs to the technical field of pipeline magnetization inspection, in particular, relates to a pipeline in-line inspection tool based on distributed magnetic uniformity sensing.

### BACKGROUND

Pipelines are widely used to transport oil, gas, chemicals, water and other industrial media. If defects or damage in pipelines are not detected in time, it may cause major accidents such as leakage, fire or even explosion, endangering personal safety and the environment. Through regular inspections, problems such as corrosion, cracks, welding defects, etc. in pipelines can be discovered in advance, preventing catastrophic accidents.

At present, magnetic flux leakage inspection technology is often used to detect pipelines. The conventional magnetization method is the overall magnetization method, which is to use the central cylinder (iron lining), the front and rear sets of steel brushes and the magnetic part to be detected (pipe wall) to form a longer magnetic circuit, and the entire pipe section between the front and rear sets of steel brushes is magnetized as a whole. The effective range of the instantaneous inspection of the magnetic sensitive probe is the entire pipe section between the steel brushes, and the defects of the entire magnetized pipe section are detected.

However, conventional magnetic flux leakage inspection technology uses the central cylinder (iron liner) as the yoke part of the magnetic circuit, resulting in strong magnetism in the central cylinder as a whole. Components susceptible to strong magnetic interference, such as energy supply units (batteries) and electronic hardware, cannot be placed in the central cylinder, resulting in low equipment integration and complex structure. This increases the difficulty of manufacturing and maintenance costs of the equipment, and makes it difficult to pass through narrow areas of pipes such as bends and valves.

### SUMMARY

In order to solve the problems in the prior art, the invention provides a pipeline in-line inspection tool based on distributed magnetic uniformity sensing.

In order to achieve the foregoing objective, technical solutions of the invention are:
The invention provides a pipeline in-line inspection tool based on distributed magnetic uniformity sensing, which includes a mobile carrier and a probe inspection assembly;
the mobile carrier moves in the pipeline;
a plurality of probe inspection assemblies are arranged on an outer side of the mobile carrier, and the plurality of probe inspection assemblies are distributed in sequence along an axis of the mobile carrier;
the probe inspection assembly includes a plurality of elastic inspection ends, and the plurality of elastic inspection ends are distributed and arranged around the axis of the mobile carrier;
the elastic inspection end is provided with an excitation structure, an inspection component and a wear-resistant structure;
wherein during inspection, the elastic inspection end is in abutment with an inner wall of the pipeline, the pipeline is magnetized through the excitation structure, and pipeline defects in magnetized areas are detected through the inspection component.

The beneficial effects of the invention are:

The invention provides a pipeline in-line inspection tool based on distributed magnetic uniformity sensing, which utilizes magnetic uniformity coupling sensing inspection technology to perform pipeline inspection, and can detect both internal defects in the magnetized area of the pipeline and external defects in the magnetized area, without using a central cylinder as a magnetic circuit, thereby making it easier to lay out tools, improving equipment integration, simplifying the structure, reducing equipment manufacturing difficulty and maintenance costs, and facilitating passing through narrow pipe areas such as elbows and valves.

### BRIEF DESCRIPTION OF THE DRAWINGS

FIG. 1 is a three-dimensional structural view of a pipeline in-line inspection tool based on distributed magnetic uniformity sensing according to the invention;

FIG. 2 is a front view of the pipeline in-line inspection tool based on distributed magnetic uniformity sensing according to the invention;

FIG. 3 is an axonometric drawing of a single inspection probe assembly according to the invention;

FIG. 4 is a side view of the single inspection probe assembly according to the invention;

FIG. 5 is a partial view of mounting the single inspection probe assembly at a fixed position according to the invention;

FIG. 6 is a view of an unfolded and laid-out two-circle probe inspection assembly according to the invention;

FIG. 7 is a view of mounting a small-sized wear-resistant body according to the invention;

FIG. 8 is a front view of the small-sized wear-resistant body according to the invention;

FIG. 9 is a view of mounting a large-sized wear-resistant body according to the invention.

### DESCRIPTION OF REFERENCE NUMERALS

1-mobile carrier; 2-probe inspection assembly; 21-connecting end; 211-fixing platform; 22-transition connecting end; 23-elastic inspection end; 231-fixed pad; 2311-fixed inclined surface; 2312-strip-shaped counterbore; 232-fixed cover plate; 2321-concave countersink; 2322-limit ridge 1; 2323-limit ridge 2; 233-small-sized wear-resistant body; 2331-wear-resistant spherical surface; 2332-conical wear-resistant body; 2333-limit cylinder; 234-large-sized wear-resistant body; 2341-wear-resistant curved surface; 2342-central concave body; 2343-strip-shaped boss; 235-magnetic sensor; 236-magnetized area; 24-transition fillet; 25-cable; 26-deformation groove; 3-mileage inspection component; 4-sealing cup washer; 5-pressure-resistant connector; 6-pressure ring; 61-step ridge.

### DETAILED DESCRIPTION OF THE EMBODIMENTS

Clear and intact description will be made on technical schemes in the embodiments of the invention below in combination with drawings in the embodiments of the invention. Obviously, the described embodiments are merely a part of embodiments of the invention and are not all the embodiments. Based on the embodiments of the invention, all other embodiments obtained by those skilled in the art without involving any inventive effort are within the scope of the invention.

Specific embodiments provided by the invention are as follows.

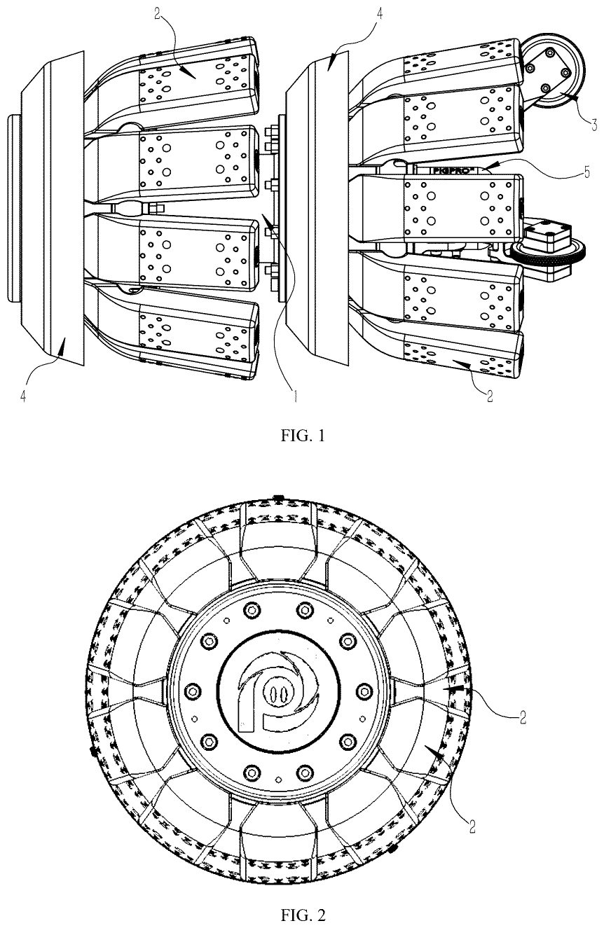

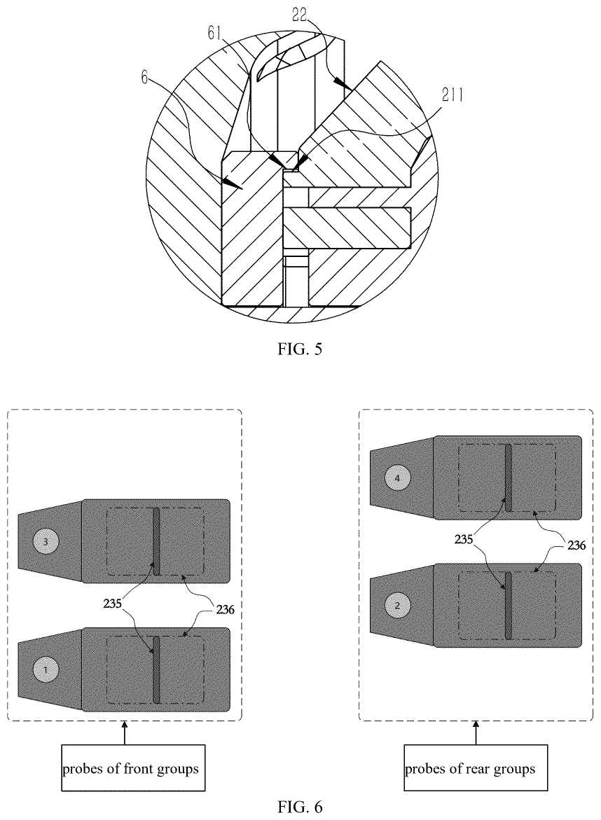

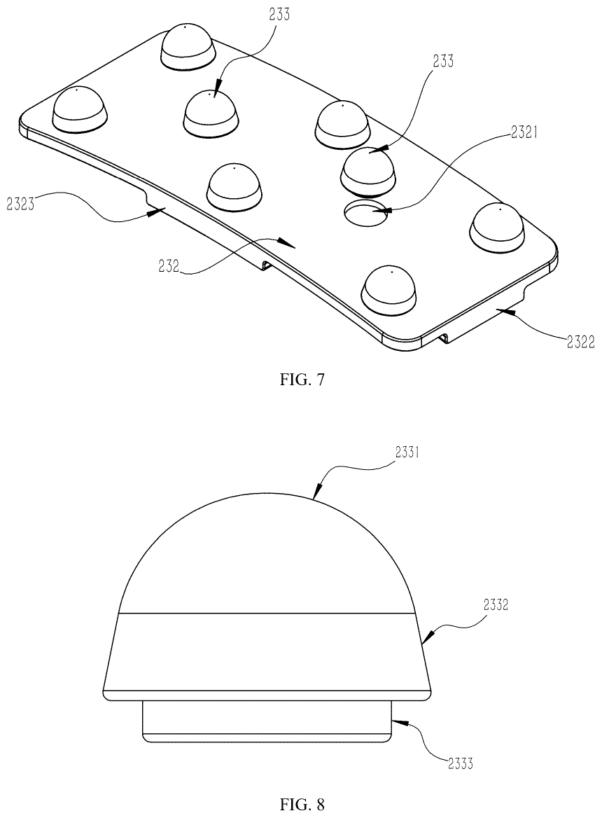

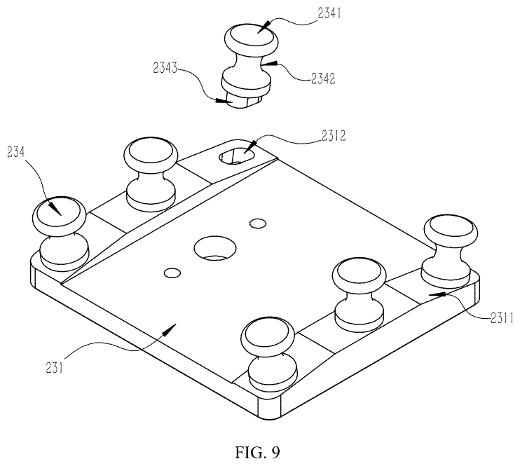

As shown in FIGS. 1 to 9, the first embodiment of the invention provides a pipeline in-line inspection tool based on distributed magnetic uniformity sensing, which includes a mobile carrier 1 and a probe inspection assembly 2; the mobile carrier 1 moves in the pipeline, a plurality of probe inspection assemblies 2 are arranged on an outer side of the mobile carrier 1, and the plurality of probe inspection assemblies 2 are distributed in sequence along an axis of the mobile carrier 1; the probe inspection assembly 2 includes a plurality of elastic inspection ends 23, and the plurality of elastic inspection ends 23 are distributed and arranged around the axis of the mobile carrier 1; the elastic inspection end 23 is provided with an excitation structure, an inspection component and a wear-resistant structure;
wherein during inspection, the elastic inspection end 23 is in abutment with an inner wall of the pipeline, the pipeline is magnetized through the excitation structure, and pipeline defects in magnetized areas are detected through the inspection component.

Optionally, the probe inspection assembly 2 may be arranged in multiple circles, with the front and rear circles arranged alternately, and each of the probe inspection assemblies 2 detects defects within the scope of respective magnetized area 236. By arranging the plurality of probe inspection assemblies 2 in a staggered manner in front and behind, full coverage of the inspection range may be achieved.

In the invention, due to the use of distributed interval magnetization, the magnetic circuit is shorter, and under the same magnetization intensity requirement for the magnetic pipeline being detected, the magnetism of a single probe inspection assembly 2 is lower; furthermore, when the tool of the invention establishes a magnetic circuit, the mobile carrier 1 is not used as a part of the magnetic circuit, and the elastic inspection end 23 of the single probe inspection assembly 2 is far away from the mobile carrier 1, so that the mobile carrier 1 is completely non-magnetic; furthermore, the mobile carrier 1 of the invention may normally accommodate energy supply units (batteries) and electronic hardware and other components susceptible to strong magnetic interference, which is convenient for tool layout and improves equipment integration; meanwhile, the structure is simple, and the manufacturing difficulty and maintenance cost of the equipment may be reduced, while being helpful to pass through narrow areas of pipes such as elbows and valves.

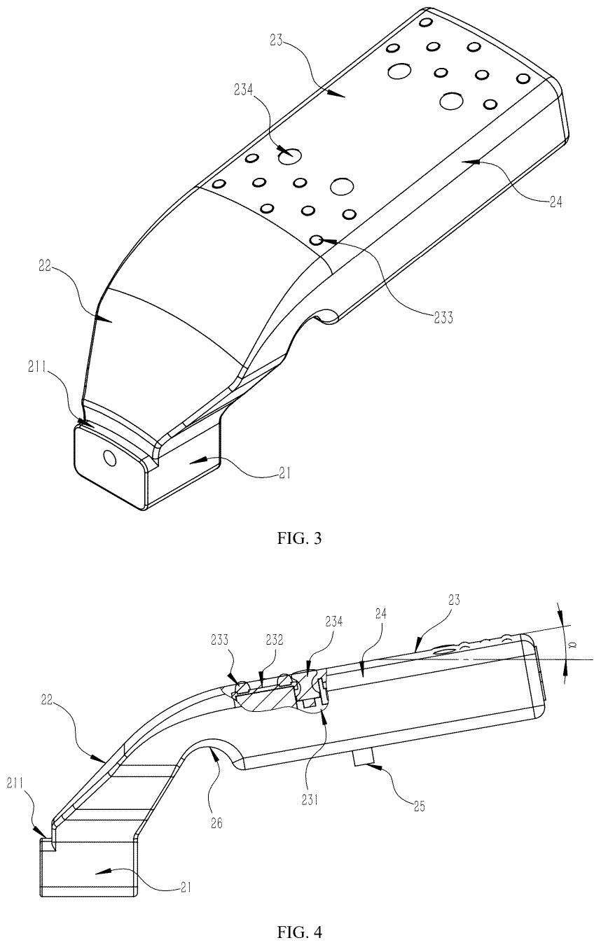

Further, the pipeline in-line inspection tool provided by the invention has reduced size, reduced weight and high resolution. Taking the 8-inch pipeline detector in this industry as an example, the total length of the tool of the invention may reach 390 mm (the conventional magnetic flux leakage detector structure adopts a multi-section layout design, with an overall length of about 2500 mm, less than one-sixth thereof), which reduces the requirements for the inspection working conditions and meets the working conditions of 1.5D elbows, ball valves, etc. ((the conventional magnetic flux leakage inspection is often composed of multiple sections with large length dimensions and cannot meet the working requirements of 1.5D, ball valves, etc.). The total weight of the equipment of the invention may reach 18.2 Kg (for the conventional magnetic flux leakage detector structure-see FIG. 2, the overall weight is about 100 Kg, less than one-fifth thereof), which greatly reduces the weight, thereby reducing the friction between the detector and the detected object, thereby reducing the wear resistance requirements of the inspection section. The structure of the invention may lay out 320 main channels (the conventional magnetic flux leakage tool has about 200 main channels, which is about 68% higher than the conventional magnetic flux leakage inspection equipment), which improves the inspection resolution, facilitates defect imaging, and intuitively reflects the morphological characteristics of the detected defects.

In a possible embodiment, the probe inspection assembly 2 further includes a connecting end 21. The probe inspection assembly 2 is connected with the mobile carrier 1 through the connecting end 21. The connecting end 21 is provided with a fixing platform 211. When the probe inspection assembly 2 is mounted and fixed on the mobile carrier 1 by using a pressure ring 6, a step ridge 61 of the pressure ring 6 is clamped with the fixing platform 211.

In the invention, since an excitation structure is embedded in the elastic inspection end 23, there is an adsorption force between the single probe inspection assembly 2 and the magnetic pipe being detected, and there is an outward pulling force at the elastic inspection end 23, which makes it easy for the single probe inspection assembly 2 to be pulled out from the fixed mounting position area, causing the single probe inspection assembly 2 to fall. Therefore, the anti-drop fixing platform 211 structure is added to prevent the single probe inspection assembly 2 from being pulled off and falling from the mounting position.

In a possible embodiment, transition fillets 24 are arranged on both sides of a contact surface between the elastic inspection end 23 and the inner wall of the pipeline.

In the invention, the actual movement mode of the in-line inspection tool in the pipeline is a composite movement composed of axial linear movement and circumferential rotational movement. The circumferential rotational movement will cause the single probe inspection assembly 2 to vibrate. The transition fillets 24 are added on both sides of the single probe inspection assembly 2, so that smooth transition may reduce probe jitter and improve data quality.

In a possible embodiment, since the elastic inspection end 23 is embedded with an excitation structure, there is an adsorption force between the single probe inspection assembly 2 and the detected magnetic pipe, the transition connecting end 22 in the single probe inspection assembly 2 is not required to provide a large outward tension, thereby reducing the size of the probe outward angle α.

In the invention, an outward angle of the elastic inspection end 23 is reduced, the outward tension provided by the transition connecting end 22 is reduced, and the pressure between the elastic inspection end 23 and the detected magnetic pipe is reduced, thereby reducing the friction between the elastic inspection end 23 and the detected magnetic pipe and reducing the wear resistance requirements of the elastic inspection end 23.

In a possible embodiment, the probe inspection assembly 2 further includes a transition connecting end 22. The connecting end 21 is connected with the elastic inspection end 23 through the transition connecting end 22. A deformation groove 26 is arranged between the transition connecting end 22 and the elastic inspection end 23.

In the invention, the deformation groove 26 is added, so that when the single probe inspection assembly 2 is radially deformed, the single probe inspection assembly bends and deforms at a preset position, and the transition connecting end 22 no longer bends and deforms and plays an independent supporting role to meet the preset deformation requirements, so that the elastic inspection end 23 may better fit the inner wall of the magnetic pipe being detected.

In a possible embodiment, an outlet position of the cable 25 of the single probe inspection assembly 2 moves from the transition connecting end 22 to the elastic inspection end 23.

In the invention, the outlet position of the cable 25 of the single probe inspection assembly 2 is moved to the elastic inspection end 23 area, and the cable does not pass through a bending part of the deformation groove 26, so as to avoid the deformation of the probe during use, which may cause the cable to be pulled and cause the solder joint to fall off. At the same time, the integrity of the elastic material of the single probe inspection assembly 2 at the deformation groove 26 is ensured, and the tensile strength of the deformation portion is improved.

In a possible embodiment, the elastic inspection end 23 includes a fixed cover plate 232 in contact with the inner wall of the pipeline and a magnetic sensor 235. The wear-resistant structure includes a plurality of small-sized wear-resistant bodies 233 and a large-sized wear-resistant body 234. The plurality of the small-sized wear-resistant bodies 233 are arranged on the fixed cover plate 232. A plurality of large-sized wear-resistant bodies 234 are arranged in an area between the fixed cover plate 232 and the magnetic sensor 235.

It should be noted that the adsorption force between the fixed cover plate 232 and the contact part of the detected magnetic pipe is the largest. This part is the adsorption pressure concentration area and is most prone to wear and rupture. Therefore, the plurality of small-sized wear-resistant bodies 233 are arranged in this area.

Further, a small number of large-sized wear-resistant bodies 234 are arranged in the area between the fixed cover plate 232 and the magnetic sensor 235. The large-sized wear-resistant bodies 234 have both the function of wear resistance and the function of protecting the inspection unit, and also play the role of supporting between the single probe inspection assembly 2 and the magnetic pipe being detected.

In the invention, when the detector is conducting inspection in the pipeline, the actual movement mode of the detector in the pipeline is a composite motion composed of axial linear motion and circumferential rotational motion. There are sharp and hard objects protruding radially on the inner wall of the pipeline. Since the top of the wear-resistant body is of a spherical structure, sharp and protruding hard objects moving in all directions may smoothly transition to the wear-resistant column without impacting the wear-resistant column and causing to break. Meanwhile, the wear-resistant body is higher than an outer arc surface of the elastic inspection end 23, ensuring that when the single probe inspection assembly 2 is normally fitted in the pipeline, the contact points between the elastic inspection end 23 and the inner wall of the pipeline are the protruding wear-resistant bodies 233, 234. Normal wear of the protruding wear-resistant bodies 233 and 234 avoids wear of the potting material. An exposed part of the top spherical surface of the wear-resistant body is smaller than the spherical radius, which ensures that most of the wear-resistant bodies 233 and 234 are encapsulated in the potting material, forming a “small mouth and big belly” wrapping effect to prevent the wear-resistant bodies 233 and 234 from falling.

In a possible embodiment, the fixed cover plate 232 is covered on the excitation structure (magnetization source); the fixed cover plate 232 is completely fitted with the excitation structure, and the fixed cover plate 232 is provided with limit ridges 2322 and 2323 around to completely fix the fixed cover plate 232 on the excitation structure to prevent movement around.

Optionally, the fixed cover plate 232 is made of a high magnetic permeability material and may be directly and strongly adsorbed on the excitation structure, thereby preventing the fixed cover plate 232 from falling radially. Since the fixed cover plate 232 is made of the high magnetic permeability material, a thickness of the elastic potting material between the excitation structure and the detected magnetic pipe is reduced, thereby enhancing the magnetization effect of the magnetic circuit.

In a possible embodiment, the fixed cover plate 232 is provided with a plurality of concave countersinks 2321. The small-sized wear-resistant bodies 233 are fixedly placed in the concave countersinks 2321 one by one.

Optionally, the layout of the concave countersink 2321 and the small-sized wear-resistant body 233 may be varied according to the needs, such as linear, spiral, discrete, etc.

In the invention, the concave countersink 2321 plays the role of fixing the small-sized wear-resistant body 233 on the four sides of the plane, so as to prevent the small-sized wear-resistant body 233 from being displaced by collision during operation.

In a possible embodiment, the small-sized wear-resistant body 233 is of a conical mushroom-head type gyratory body structure.

It should be noted that the conical mushroom-head type gyratory body structure is larger at the bottom and smaller at the top. This structure ensures that after the single probe inspection assembly 2 is manufactured, most of the lower part of the small-sized wear-resistant body 233 is completely wrapped in the potting material; the potting material has a “small mouth and big belly” wrapping effect on the small-sized wear-resistant body 233, so that the small-sized wear-resistant body 233 may not be pulled out.

Further, a protruding limit cylinder 2333 is provided at a bottom of the small-sized wear-resistant body 233, and this structure is used to cooperate with the concave countersink 2321 of the fixed cover plate 232 to ensure the limit effect on the small-sized wear-resistant body 233 on all sides.

Further, a top of the small-sized wear-resistant body 233 is provided with a wear-resistant spherical surface 2331, and the top is of a spherical structure; the small-sized wear-resistant body 233 is higher than an upper surface of the potting material, but a higher part is smaller than a radius of the spherical surface.

In a possible embodiment, the elastic inspection end 23 further includes a fixed pad 231. The fixed pad 231 is symmetrically provided with fixed inclined surfaces 2311, and the fixed inclined surfaces 2311 are provided with strip-shaped counterbores 2312. The large-sized wear-resistant body 234 is provided with a strip-shaped boss 2343. The large-sized wear-resistant body 234 is arranged in the fixed pad 231 through the cooperation between the strip-shaped boss 2343 and the strip-shaped counterbore 2312.

Optionally, the cross-sectional shape of the strip-shaped counterbore 2312 may be a non-rotating body, not necessarily in a long-strip shape.

It should be noted that the large-sized wear-resistant body 234 needs to be arranged in an arc on the outer arc surface of the elastic inspection end 23 of the single probe inspection assembly 2; therefore, it is necessary to add symmetrically-arranged fixed inclined surfaces 2311 on the fixed pad 231 according to the arc layout position, and the size of the inclined surface depends on the layout position. The cooperation between the strip-shaped boss 2343 and the strip-shaped counterbore 2312 ensures the limit effect on the large-sized wear-resistant body 234 and prevents the large-sized wear-resistant body 234 from rotating and displacing on all sides.

In a possible embodiment, the large-sized wear-resistant body 234 is of a multi-layer mushroom-head type gyratory body structure. The large-sized wear-resistant body 234 is provided with a structure with a concave middle portion 2432 so that the large-sized wear-resistant body 234 is small in the middle and large at both ends. A lower mushroom head of the large-sized wear-resistant body 234 is completely wrapped in the potting material. The potting material has a “small mouth and big belly” wrapping effect on the large-sized wear-resistant body 234, so that the large-sized wear-resistant body 234 may not be pulled out. An upper mushroom head of the large-sized wear-resistant body 234 contacts the inner wall of the pipeline.

Optionally, the large-sized wear-resistant body 234 has an “upper mushroom head” structure at the top, and the top is a wear-resistant arc surface 2341; a top wear-resistant arc surface 2341 of the “upper mushroom head” structure of the large-sized wear-resistant body 234 is higher than an upper surface of the potting material, but the higher part is smaller than the spherical radius.

Further, the small-sized wear-resistant body 233 and the large-sized wear-resistant body 234 are combined in terms of size, layout quantity, layout position, and structural method. This combination method functionally separates the wear-resistant and supporting functions to avoid failure under complex working conditions.

In a possible embodiment, with the goal of improving magnetic induction, improving wear resistance, reducing friction and reducing manufacturing costs, sizes and positions of the small-sized wear-resistant body 233 and the large-sized wear-resistant body 234 are determined by a fireworks algorithm.

Specifically, the small-sized wear-resistant bodies are usually distributed around the magnetization source and are mainly responsible for wear resistance and support functions, with a design in shape under the consideration of the balance between wear resistance and friction. The parameters to be determined for the small-sized wear-resistant bodies mainly include: material, wear-resistant spherical radius, exposed height, quantity and position.

The large-sized wear-resistant body is responsible for providing greater support and wear resistance, while the structural design thereof also affects the magnetic induction performance and overall wear characteristics. The parameters to be determined for the large-sized wear-resistant bodies mainly include: material, radius of the upper wear-resistant spherical surface, exposed height, overall height, middle concave depth, width and length of strip-shaped boss, quantity and position.

Specifically, COMSOL, ANSYS, etc. may be used to build a simulation model of the pipeline in-line inspection tool based on distributed magnetic uniformity sensing. The simulation model is used to determine the magnetic inductance, wear resistance and friction for various parameter combinations. It is necessary to define the contact characteristics between the wear-resistant body and the inner wall of the pipeline, including the contact area, contact friction, clamping force and friction coefficient. It is necessary to select nonlinear contact or surface-to-surface contact to simulate the interaction between the wear-resistant body and the pipeline wall. At the same time, the magnetic field boundary conditions between the wear-resistant body and the pipeline need to be defined, including the source and magnetization intensity of the external magnetic field.

Further, necessary constraints are imposed on the wear-resistant body, such as fixing the center of the probe, so that the wear-resistant body may only move or displace in a specific direction. The motion of the probe in the pipeline is simulated, and the motion trajectory and speed of the probe are defined to analyze the friction and wear resistance under different conditions.

Further, a normal load between the wear-resistant body and the inner wall of the pipeline is applied to simulate the pressure under actual working conditions. A sliding friction load is set to simulate the friction between the wear-resistant body and the pipeline wall when the probe moves in the pipeline.

Further, high-precision meshing is used, especially in contact areas and areas where the magnetic field changes drastically. The contact area between the wear-resistant body and the pipeline wall and the key parts of the probe require refined meshes to obtain accurate stress distribution, wear distribution and magnetic field distribution.

Optionally, the magnetic induction may be specifically evaluated by the strength and stability of the magnetic induction signal received by the magnetic sensor:

$$E = β I + ( 1 - β ) S$$

wherein E represents the magnetic inductance parameter; I represents the strength of the magnetic induction signal; S represents the stability of the magnetic induction signal; p represents the weight coefficient of the magnetic induction signal strength.

Optionally, the stability of the magnetic induction signal may be evaluated using the variance and standard deviation of the intensity of the magnetic induction signal.

It should be noted that the inspection accuracy for pipeline faults may be improved by improving the magnetic induction parameters.

Optionally, the wear resistance may be evaluated by the amount of wear:

$$W = \frac{K \times P \times V}{H}$$

wherein W represents the amount of wear; K represents the wear coefficient; P represents the contact pressure; V represents the relative sliding velocity; H represents the material hardness.

It should be noted that by reducing the amount of wear, the service life of the wear-resistant body may be extended, the reliability of the inspection tool may be improved, and the maintenance cost may be reduced.

Optionally, the friction force is specifically:

$$F = μ \times N$$

wherein F represents the friction force; N represents the contact pressure (normal force), and μ represents the material friction coefficient.

Optionally, the cost may be evaluated using the material cost:

$$B = {b}_{1} {V}_{1} + {b}_{2} {V}_{2}$$

wherein B represents the material cost, b₁ represents the unit material cost of small-sized wear-resistant bodies; V₁ represents the total volume of small-sized wear-resistant bodies; b₂ represents the unit material cost of large-sized wear-resistant bodies; V₂ represents the total volume of large-sized wear-resistant bodies.

It should be understood that magnetic induction parameters, wear resistance, friction force and material cost are evaluation indicators that affect each other. For example, often materials with high wear resistance and low friction force will cost more. For example, in order to improve wear resistance, it is usually necessary to select materials with high hardness and high wear resistance, such as ceramics, cemented carbide or high-strength composite materials. However, these materials tend to have low magnetic permeability, meaning conducting magnetic fields poorly. The intensity of the magnetic induction signal depends on the magnetic field received by the sensor, and low magnetic permeability materials will weaken the penetration of the magnetic field, resulting in a decrease in the intensity of the magnetic induction signal or an unstable signal.

Therefore, the above-magnetic induction parameters, wear resistance, friction force and material cost are contradictory evaluation indicators and need to be considered comprehensively. Therefore, a comprehensive fitness function is designed:

$$f ( θ ) = {λ}_{1} E - {λ}_{2} W - {λ}_{3} F - {λ}_{4} B$$

wherein f represents the fitness function; θ represents the size parameter combination; the size parameter combination includes the material, wear-resistant spherical radius, exposed height, quantity, and position of the small-sized wear-resistant body, and the material, upper wear-resistant spherical radius, exposed height, overall height, middle concave depth, strip boss width and length, quantity, and position of the large-sized wear-resistant body; λ₁ represents the weight coefficient of magnetic induction parameter; λ₂ represents the weight coefficient of wear; λ₃ represents the weight coefficient of friction; λ₄ represents the weight coefficient of material cost.

The firework individuals is initiated, each of the firework individuals being composed of a plurality of dimensional components, each of the firework individuals representing a feasible size parameter combination, each of the components representing a size parameter.

Explosion operations are performed on each of the firework individuals:

$${A}_{i} = \frac{{C}_{A} [ f ( {x}_{i} ) − {f}_{min} + ε ]}{{\sum }_{i = 1}^{N} [ f ( {x}_{i} ) − {f}_{min} ] + ε}$$

$${S}_{i} = \frac{{C}_{S} [ {f}_{max} − f ( {x}_{i} ) + ε ]}{{\sum }_{i = 1}^{N} [ {f}_{max} − f ( {x}_{i} ) ] + ε}$$

wherein Aᵢ represents the explosion radius of the i-th firework individual; xᵢ represents the i-th firework individual; f represents the fitness function; N represents the total number of firework individuals; min represents the minimum value; ε represents a hyperparameter to avoid division by zero; C_{A} represents the explosion radius adjustment coefficient; Sᵢ represents the number of explosion sparks of the i-th firework individual; max represents taking the maximum value; C_{S} represents the explosion spark number adjustment coefficient.

In the invention, the individual with better fitness has a smaller explosion radius, indicating a search in a finer local area; the individual with poorer fitness has a larger explosion radius and may explore new solutions in a wider range.

Further, the individuals with poorer fitness generate more sparks, indicating having more exploration opportunities; the individuals with better fitness have fewer sparks to reduce ineffective search behavior.

The number of explosion sparks generated by the explosion operation is limited:

$${S}_{i}^{⋆} = \{ \begin{matrix}{S}_{max} & {S}_{i} > {S}_{max} \\ {S}_{i} & {S}_{min} \leq {S}_{i} \leq {S}_{max} \\ {S}_{min} & {S}_{i} < {S}_{min}\end{matrix}$$

wherein

$${S}_{i}^{⋆}$$

represents the number of explosion sparks of the i-th firework after restriction processing; Sₘₐₓ represents the maximum number of explosion sparks; Sₘᵢₙ represents the minimum number of explosion sparks.

Those skilled in the art can set the maximum number of explosion sparks and the minimum number of explosion sparks according to actual conditions, and the invention does not limit this.

In the invention, limiting the range of spark numbers helps balance global exploration with local search. When the number of sparks is moderate, both extensive global search and fine search in local areas may be performed, thereby increasing the probability of finding the global optimal solution.

Some firework individuals are randomly selected, a random number is generated, and whether the random number is less than the mutation probability is determined, wherein if so, Gaussian mutation operation is performed:

$${x}_{ij}^{⋆} = {x}_{ij} \times e$$

wherein

$${x}_{ij}^{⋆}$$

represents the j-th dimension component in the i-th firework individual after Gaussian mutation; xᵢⱼ represents the j-th dimension component in the i-th firework individual; e represents a random number that satisfies a Gaussian distribution with a mean of 1 and a variance of 1.

In the invention, the Gaussian mutation operation increases the diversity of the population by introducing random numbers to randomly perturb the dimensional components of individuals. Through mutation, the individuals in each generation will not converge too early, thus preventing the entire population from quickly converging to the local optimal solution.

Optionally, the mutation probability is specifically:

$${P}_{m} = \{ \begin{matrix}{P}_{m , max} − \frac{( {P}_{m , max} − {P}_{m , min} ) ( f − {f}_{avg} )}{{f}_{max} − {f}_{avg}} & f \geq {f}_{avg} \\ {P}_{m , max} & f < {f}_{avg}\end{matrix}$$

wherein Pₘ represents the mutation probability; P_{m,max} represents the maximum mutation probability; P_{m,min} represents the minimum mutation probability; f represents the fitness value of the current individual; f_{avg} represents the average fitness value of the population; fₘₐₓ represents the maximum fitness value of the individual.

In the invention, the probability of mutation for the individuals with better fitness is smaller, which means that these individuals are close to the optimal solution. Reducing mutation may prevent them from deviating from the current good solution. The mutation probability of the individuals with poor fitness is the highest, indicating that these individuals need stronger randomness to explore new solutions.

Mapping operations are performed on each of the firework individuals:

$${x}_{i j}^{′} = {L}_{j} + \vert {x}_{i j} \vert \% ( {U}_{j} − {L}_{j} )$$

wherein

$${x}_{i j}^{′}$$

represents the j-th dimension component in the i-th firework individual after the mapping operation; Lⱼ represents the lower limit of the j-th dimension; Uⱼ represents the upper limit of the j-th dimension; % represents the modulo operation.

In the invention, during the search process, some dimensional components may exceed the given upper and lower limits (for example, design variables such as size and position have physical limitations). Through the mapping operation, the components of the solution may be constrained back to the feasible solution space to ensure that the rationality and effectiveness of the algorithm operation are not affected by solutions that exceed the design space.

Selection operations are performed on each of the firework individuals, wherein the probability of each of the firework individuals being selected is:

$$P ( {x}_{i} ) = \frac{D ( {x}_{i} )}{{\sum }_{i = 1}^{N} D ( {x}_{i} )}$$

$$D ( {x}_{i} ) = {\sum }_{u = 1 , u \neq 1}^{N} d ( {x}_{i} , {x}_{u} )$$

wherein P represents the selection probability; D represents the sum of the distances between the current individual and other individuals except the current individual; d represents the Euclidean distance between two individuals; xᵤ represents the u-th firework individual.

In the invention, determining the selection probability by distance may encourage the individuals with larger distances (i.e., individuals with higher diversity) in the population to be selected preferentially. The individuals with larger distances represent that they are significantly different from other individuals, which can help the population explore more potential solution spaces.

Whether the current number of iterations has reached the maximum number of iterations is determined. If so, the firework individual representative with the highest current fitness is output. Otherwise the method returns to continue iterating.

In the invention, optimizing the size and position of the small-sized and large-sized wear-resistant bodies through the fireworks algorithm helps to balance magnetic induction, wear resistance, friction force and manufacturing cost, thereby improving the overall performance of pipeline inspection equipment.

The beneficial effects of the invention are:
The invention provides a pipeline in-line inspection tool based on distributed magnetic uniformity sensing, which utilizes magnetic uniformity coupling sensing inspection technology to perform pipeline inspection, and can detect both internal defects in the magnetized area of the pipeline and external defects in the magnetized area, without using a central cylinder as a magnetic circuit, thereby making it easier to lay out tools, improving equipment integration, simplifying the structure, reducing equipment manufacturing difficulty and maintenance costs, and facilitating passing through narrow pipe areas such as elbows and valves.

In the description of the embodiments of the present invention, it needs to be understood that terms such as “up”, “down”, “front”, “back”, “left”, “right”, “vertical”, “horizontal”, “center”, “top”, “bottom”, “top”, “bottom”, “inside”, “outside”, “inside”, and “outside” indicate orientation or positional relationships.

In the description of the embodiments of the present invention, it should be noted that, unless otherwise clearly stipulated and limited, the terms “install”, “communicate”, “connect” and “assemble” should be understood in a broad sense. For example, it can be a fixed connection, a detachable connection, or an integral connection; it can be a direct connection, or an indirect connection through an intermediate medium, or it can be the internal connection of two elements. For those of ordinary skill in the art, specific meanings of the above terms in the present invention may be understood based on specific situations.

In the description of the foregoing embodiments, specific features, structures, materials, or characteristics may be combined in any one or more embodiments or examples in an appropriate manner.

In the description of the embodiments of the present invention, it should be understood that “-” and “˜” represent a range between two numerical values, and the range includes the endpoints. For example, “A-B” means a range greater than or equal to A and less than or equal to B. “A-B” means a range greater than or equal to A and less than or equal to B.

In the description of the embodiments of the present invention, the term “and/or” herein only describes an association relationship between associated objects, and can denote three relationships, for example, A and/or B can denote A, both A and B, and B. In addition, the character “/” herein generally denote that the former and latter associated objects are in an “or” relationship.

Although the embodiments of the present invention have been shown and described, it can be understood that a person skilled in the art can make various changes, modifications, substitutions and variations to the embodiments without departing from the principle and spirit of the present invention; and the scope of the present invention is defined by the attached claims and equivalents thereof.

1. A pipeline in-line inspection tool based on distributed magnetic uniformity sensing, comprising a mobile carrier and a probe inspection assembly; wherein
the mobile carrier moves in a pipeline;
a plurality of probe inspection assemblies are arranged on an outer side of the mobile carrier, and the plurality of probe inspection assemblies are distributed in sequence along an axis of the mobile carrier;
each of the plurality of probe inspection assemblies comprises a plurality of elastic inspection ends, and the plurality of elastic inspection ends are distributed and arranged around the axis of the mobile carrier;
each of the plurality of elastic inspection ends is provided with an excitation structure, an inspection component and a wear-resistant structure;
wherein during inspection, each of the plurality of elastic inspection ends is in abutment with an inner wall of the pipeline, the pipeline is magnetized through the excitation structure, and pipeline defects in magnetized areas are detected through the inspection component;
each of the plurality of elastic inspection ends comprises a fixed cover plate in contact with the inner wall of the pipeline and a magnetic sensor;
the wear-resistant structure comprises a plurality of small-sized wear-resistant bodies and a large-sized wear-resistant body;
the plurality of small-sized wear-resistant bodies are arranged on the fixed cover plate;
the large-sized wear-resistant body is arranged in an area between the fixed cover plate and the magnetic sensor;
the fixed cover plate is provided with a plurality of concave countersinks;
the plurality of small-sized wear-resistant bodies are fixedly placed in the plurality of concave countersinks one by one;
each of the plurality of elastic inspection ends further comprises a fixed pad;
the fixed pad is symmetrically provided with fixed inclined surfaces, and the fixed inclined surfaces are provided with strip-shaped counterbores;
the large-sized wear-resistant body is provided with a strip-shaped boss;
the large-size wear-resistant body is arranged in the fixed pad by a cooperation between the strip-shaped boss and the strip-shaped counterbores;
the large-sized wear-resistant body is of a multi-layer mushroom-head type gyratory body structure;
the large-sized wear-resistant body is provided with a structure with a concave middle portion so that the large-sized wear-resistant body is small in middle and large at both ends;
a first mushroom head at a lower end of the large-sized wear-resistant body is completely wrapped in an injection material;
a second mushroom head at an upper end of the large-sized wear-resistant body is in contact with the inner wall of the pipeline;
with a goal of improving magnetic induction, improving wear resistance, reducing friction and reducing manufacturing costs, sizes and positions of the plurality of small-sized wear-resistant bodies and the large-sized wear-resistant body are determined by a fireworks algorithm;
a fitness function of the fireworks algorithm is expressed as:
$$f ( θ ) = {λ}_{1} E - {λ}_{2} W - {λ}_{3} F - {λ}_{4} B$$
wherein f represents the fitness function; θ represents a size parameter combination; the size parameter combination comprises a material, a wear-resistant spherical radius, an exposed height, a quantity, and a position of each of the plurality of small-sized wear-resistant bodies, and a material, an upper wear-resistant spherical radius, an exposed height, an overall height, a middle concave depth, a strip boss width and length, a quantity, and a position of the large-sized wear-resistant body; E represents a magnetic induction parameter; W represents a wear amount; F represents a friction force; B represents a material cost; λ₁ represents a weight coefficient of the magnetic induction parameter; λ₂ represents a weight coefficient of wear; λ₃ represents a weight coefficient of friction; and λ₄ represents a weight coefficient of the material cost;
$$E = β 1 + ( 1 - β ) S$$
wherein I represents a strength of a magnetic induction signal; S represents a stability of the magnetic induction signal; and β represents a weight coefficient of the strength of the magnetic induction signal;
$$W = \frac{K \times P \times V}{H}$$
wherein K represents a wear coefficient; P represents a first contact pressure; V represents a relative sliding velocity; and H represents a material hardness;
$$F = μ \times N$$
wherein N represents a second contact pressure; and μ represents a material friction coefficient;
$$B = {b}_{1} {V}_{1} + {b}_{2} {V}_{2}$$
wherein bᵢ represents a unit material cost of the plurality of small-sized wear-resistant bodies; V₁ represents a total volume of the plurality of small-sized wear-resistant bodies; b₂ represents a unit material cost of the large-sized wear-resistant body; and V₂ represents a total volume of the large-sized wear-resistant body;
a method of determining the sizes and the positions of the plurality of small-sized wear-resistant bodies and the large-sized wear-resistant body by the fireworks algorithm comprises:
initializing firework individuals, each of the firework individuals being composed of a plurality of dimensional components, each of the firework individuals representing a feasible size parameter combination, and each of the plurality of dimensional components representing a size parameter;
performing explosion operations on each of the firework individuals:
$${A}_{i} = \frac{{C}_{A} [ f ( {x}_{i} ) - {f}_{min} + ε ]}{{\sum }_{i = 1}^{N} [ f ( {x}_{i} ) - {f}_{min} ] + ε}$$
$${S}_{i} = \frac{{C}_{S} [ {f}_{max} - f ( {x}_{i} ) + ε ]}{{\sum }_{i = 1}^{N} [ {f}_{max} - f ( {x}_{i} ) ] + ε}$$
wherein Aᵢ represents an explosion radius of an i-th firework individual; xᵢ represents the i-th firework individual; f represents the fitness function; N represents a total number of firework individuals; min represents a minimum value; F represents a hyperparameter to avoid division by zero; C_{A} represents an explosion radius adjustment coefficient; Sᵢ represents a number of explosion sparks of the i-th firework individual; max represents taking a maximum value; and C_{S} represents an explosion spark number adjustment coefficient;
wherein a number of explosion sparks generated by an explosion operation is limited:
$${S}_{i}^{*} = \{ \begin{matrix}{S}_{max} & {S}_{i} > {S}_{max} \\ {S}_{i} & {S}_{min} \leq {S}_{i} \leq {S}_{max} \\ {S}_{min} & {S}_{i} < {S}_{min}\end{matrix}$$
wherein
$${S}_{i}^{*}$$
represents a number of explosion sparks of the i-th firework individual after restriction processing; Sₘₐₓ represents a maximum number of explosion sparks; and Sₘᵢₙ represents a minimum number of explosion sparks;
randomly selecting some firework individuals, generating a random number, and determining whether the random number is less than a mutation probability, wherein if so, Gaussian mutation operation is performed:
$${x}_{ij}^{*} = {x}_{ij} \times e$$
wherein
$${x}_{ij}^{*}$$
represents a j-th dimension component in the i-th firework individual after Gaussian mutation; xᵢⱼ represents the j-th dimension component in the i-th firework individual; and e represents a random number that satisfies a Gaussian distribution with a mean of 1 and a variance of 1;
wherein the mutation probability is expressed as:
$${P}_{m} = \{ \begin{matrix}{P}_{m , max} - \frac{( {P}_{m , max} - {P}_{m , min} ) ( f - {f}_{avg} )}{{f}_{max} - {f}_{avg}} & f \geq {f}_{avg} \\ {P}_{m , max} & f < {f}_{avg}\end{matrix}$$
wherein Pₘ represents the mutation probability; P_{m,max} represents a maximum mutation probability; P_{m,min} represents a minimum mutation probability; f represents a fitness value of a current individual; f_{avg} represents an average fitness value of a population; and fₘₐₓ represents a maximum fitness value of an individual;
wherein mapping operations are performed on each of the firework individuals:
$${x}_{ij}^{′} = {L}_{j} + \vert {x}_{ij} \vert \% ( {U}_{j} - {L}_{j} )$$
wherein
$${x}_{ij}^{′}$$
represents the j-th dimension component in the i-th firework individual after the mapping operation; Lⱼ represents a lower limit of a j-th dimension; Uⱼ represents an upper limit of the j-th dimension; and % represents a modulo operation;
selection operations are performed on each of the firework individuals, wherein a probability of each of the firework individuals being selected is:
$$P ( {x}_{i} ) = \frac{D ( {x}_{i} )}{{\sum }_{i = 1}^{N} D ( {x}_{i} )}$$
$$D ( {x}_{i} ) = {\sum }_{u = 1 , u \neq 1}^{N} d ( {x}_{i} , {x}_{u} )$$
wherein P represents a selection probability; D represents a sum of distances between the current individual and other individuals except the current individual; d represents an Euclidean distance between two individuals; and xᵤ represents an u-th firework individual; and
determining whether a current number of iterations has reached a maximum number of iterations, wherein if so, a firework individual representative with a highest current fitness is output, and otherwise the method returns to continue iterating.

2. The pipeline in-line inspection tool based on distributed magnetic uniformity sensing according to claim 1, wherein each of the plurality of probe inspection assemblies further comprises a connecting end;
the probe inspection component is connected with the mobile carrier through the connecting end;
the connecting end is provided with a fixing platform; and
when each of the plurality of probe inspection assemblies is mounted and fixed on the mobile carrier by using a pressure ring, a step ridge of the pressure ring is clamped with the fixing platform.

3. The pipeline in-line inspection tool based on distributed magnetic uniformity sensing according to claim 1, wherein transition fillets are arranged on both sides of a contact surface between each of the plurality of elastic inspection ends and the inner wall of the pipeline.

4. The pipeline in-line inspection tool based on distributed magnetic uniformity sensing according to claim 2, wherein each of the plurality of probe inspection assemblies further comprises a transition connecting end;
the connecting end is connected with each of the plurality of elastic inspection ends through the transition connecting end; and
a deformation groove is arranged between the transition connecting end and each of the plurality of elastic inspection ends.

5. The pipeline in-line inspection tool based on distributed magnetic uniformity sensing according to claim 1, wherein each of the plurality of small-sized wear-resistant bodies is of a conical mushroom-head type gyratory body structure.
